(19) United States
(12) Patent Application Publication
(10) Pub. No.: US 2014/0238210 A1
(43) Pub. Date: Aug. 28, 2014

(54) TISSUE PERFORATING APPARATUS

(71) Applicant: KIMBERLY-CLARK WORLDWIDE, INC., Neenah, WI (US)

(72) Inventors: James Leo Baggot, Menasha, WI (US); Robert Eugene Krautkramer, Combined Locks, WI (US); Kyle Andrew Krautkramer, Kaukauna, WI (US); Gregory Michael Bixler, Appleton, WI (US); Matthew Robert Wilson, Oshkosh, WI (US); Frank Stephen Hada, Appleton, WI (US)

(73) Assignee: Kimberly-Clark Worldwide, Inc., Neenah, WI (US)

(21) Appl. No.: 13/780,718

(22) Filed: Feb. 28, 2013

(51) Int. Cl. B26D 5/00; B26D 1/40; B26D 7/26

(52) U.S. Cl. CPC B26D 5/005; B26D 7/2628; B26D 1/405
USPC 83/76.1; 83/311; 83/346

(57) ABSTRACT

The present invention provides a perforating station comprising two or more discrete perforating stations, the stations synchronized with one another to cut a line of perforations across a web, such as a web of tissue paper, moving at high speeds. By providing two or more synchronized perforating stations the perforating station may increase the number of impacts per minute compared to prior art perforating devices.

### BACKGROUND

Methods and apparatuses intended to cut or produce lines of perforations in a moving target web are well known in the art. Conventional processes and machines have included a rotary knife roll and a stationary anvil. The rotary knife rolls have included removable and replaceable knife blades, which have extended generally along the axial direction of the knife roll, and have been distributed along the circumference of the knife roll with regular or irregular, intermittent spacing. In addition, the knife blades have been placed at an angle relative to the rotational axis of the knife roll. The placing of the blades on the roll at an angle has helped to reduce the impact loads generated during the cutting of the target web. In particular arrangements, it has also been necessary to skew the axis of rotation of the knife roll relative to the direction of the web movement past the knife roll. The amount of skewing has been suitably adjusted to obtain substantially straight cuts along the transverse cross-direction of the target web. Conventional techniques and devices are well known in the art, and suitable anvils and rotary knife rolls are available from commercial vendors.

Ordinary methods and apparatuses, however, have not provided desired combinations of efficiency and versatility, particularly when the cutting processes are operated with high web speeds. When conventional processes and machines have been arranged to cut a target web that is moving at high speeds past the anvil, the impact forces between the blade and the anvil have caused high rates of wear requiring frequent changing of the knife and anvil blades. To reduce wear, the amount of interference between the knife and anvil blades has been set to relatively small values. The small values of interference help to reduce wear, but can lead to areas of missing perforations in the web, due to vibrations in the components of the equipment and variations in the setup of the equipment. A poor quality in the perforations is not only poorly received by the final consumer using the product, but can also lead to a poor operation of the manufacturing process. For example, an individual perforation line is typically used as the separation line between rolls of finished product; and a poor quality perforation line can disrupt the reliability and quality of the separation process. It has also been cumbersome and time-consuming to reconfigure conventional systems to produce different spacing between the desired cut locations along the lengthwise movement direction of the target web. As a result, there has been a continued need for improved cutting systems that provide improved reliability and versatility, along with an improved and more reliable definition of the perforation line.

### SUMMARY

To overcome the limitations of prior art perforating devices, the present inventors now provide a perforating apparatus comprising two or more discrete perforating stations, the stations synchronized with one another to cut a line of perforations across a web, such as a web of tissue paper, moving at high speeds. By providing two or more synchronized perforating stations the perforating station may increase the number of impacts per minute compared to prior art perforating devices.

Accordingly, in certain embodiments the present invention provides two or more perforating stations in synchronized control with one another, the synchronized perforating stations being capable of efficiently perforating a web, such as a tissue web, at impact rates greater than about 7000 impacts per minute and more preferably greater than about 7500 impacts per minute, with low vibrational energy and without damaging the web.

In another embodiment the present invention provides an apparatus for intermittently cutting a moving target web, comprising a first perforating station comprising a first rotating knife roll having at least one knife member to provide an operative knife-member speed and position and a first anvil member; a second perforating station comprising a second rotating knife roll having at least one knife member to provide an operative knife-member speed and position and a second anvil member; a drive means for driving the first and second knife rolls; and a control means for coordinating the operative knife-member speed and position of the first and second knife members.

In other embodiments the present disclosure provides an apparatus for intermittently cutting a moving target web, comprising a first perforating station comprising a first knife roll which has at least one knife member and is rotatable to provide an operative knife-member rotational position; a first anvil roll which has at least one anvil member the anvil roll positioned to provide a first operative nip region between the anvil roll and the knife roll; a second perforating station comprising a second knife roll which has at least one knife member and is rotatable to provide an operative knife-member rotational position; a second anvil roll, the anvil roll positioned to provide a second operative nip region between the anvil roll and the knife roll; a transport system which moves a substantially continuous target web at a web speed through the nip region; and a control system which synchronizes the rotational positioning of the first knife member with a rotational positioning of the second knife member.

In still other embodiments the present invention provides an apparatus for intermittently cutting a moving target web, comprising a first perforating station comprising a first rotating knife roll having at least one knife member to provide an operative knife-member speed and a first anvil member, the first rotating knife roll driven by a first motor; a second perforating station comprising a second rotating knife roll having at least one knife member to provide an operative knife-member speed and a second anvil member, the second rotating knife roll driven by a second motor; servo drive controllers having an internal power structure operatively connected to the first and second motors, regulating the application of power to the motor through the internal power structure of the servo drive controller; and a transport system which moves a substantially continuous target web.

### DESCRIPTION OF THE DRAWINGS

FIG. 1 illustrates one embodiment of a perforating apparatus according to the present disclosure;

FIG. 2 illustrates one embodiment of a perforating apparatus according to the present disclosure; and

FIG. 3 illustrates one embodiment of a control mechanism for synchronizing the drive motors of a perforating apparatus according to the present disclosure.

### DETAILED DESCRIPTION

Generally the apparatus of the present invention is applicable to cutting a line of perforations across a web, such as a web of tissue paper, moving at high speeds. The apparatus preferably comprises two or more perforating stations in synchronized control with one another, each apparatus preferably perforating the web at a different position. In the most basic sense each perforating station comprises a knife roll and an anvil, which are positioned relative to one another to create a nip there between through which the a moving web passes and is cut.

In conventional arrangements, the knife roll is generally a moving, rotating roll, and the anvil is generally a stationary component, however, in certain alternate embodiments the anvil may be moveable, such as a rotating anvil roll. In the method and apparatus that includes the invention, the terms knife and anvil are employed to indicate that there are two cutting components. Since both the knife and anvil are providing a cutting force to the moving web, and since the relative arrangements of the knife and anvil rolls can be substantially interchangeable, the distinction between the knife and anvil rolls may be less defined. In a particular aspect of distinction, the knife roll has knife members (e.g. knife blades) with nonlinear or notched operating edges, and the anvil roll has anvil members (e.g. anvil blades) with substantially straight operating edges.

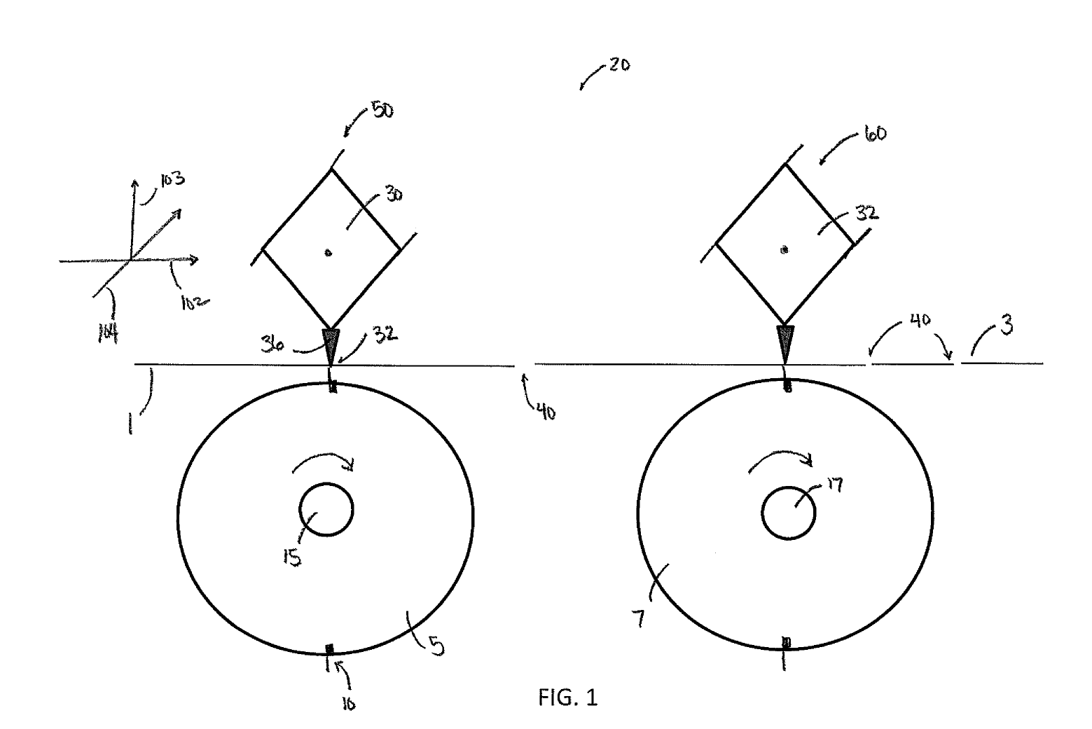

With reference to FIG. 1, the perforating stations 50, 60 are arranged such that the first station 50 provides a first set of perforations 40 and the second station 60 provides a second set of perforations 40. The perforating stations 50, 60 are synchronized such that each perforating station will perforate the web at a fixed distance. Each perforating station 50, 60 utilizes a rotary cutting concept and is applicable for making perforations on a web of tissue paper and other perforation applications. In one embodiment two adjacent rotating perforating rolls are used to generate two distinct lines of perforations on the web. In this manner the web perforator 20 has been illustrated with two perforating stations 50, 60 spaced horizontally. The perforating stations 50, 60 are synchronized such that the cuts or perforations will not occur at the same point. Although the invention is illustrated as having two perforating stations 50, 60 spaced horizontally, one skilled in the art would appreciate that additional perforating stations may be added and that the invention is not to be limited to two perforating stations and that other orientations are also within the scope of the invention.

With further reference to FIG. 1, the perforating apparatus can have a lengthwise, machine-direction 102 which extends longitudinally, a lateral cross-direction 104 which extends transversely, and an appointed z-direction 103. For the purposes of the present disclosure, the machine-direction 102 is the direction along which a particular component or material is transported length-wise along and through a particular, local position of the apparatus and method. The cross-direction 104 is aligned perpendicular to the local machine-direction 102 along the local plane of the material targeted for work, and can lie generally parallel to the local horizontal. The z-direction is aligned substantially perpendicular to both the machine-direction 102 and the cross-direction 104, and extends generally along a depth-wise, thickness dimension of the appointed material targeted for work.

Accordingly, a perforation apparatus that can intermittently produce lines of perforations 40, or can otherwise intermittently cut a moving target web 1 includes a pair of perforating stations 50, 60. The perforating stations may be substantially the same, or may be different. For simplicity, the perforating stations are described and illustrated as being substantially the same. Accordingly, the apparatus will be described with reference to only one of the perforation stations. The perforating station preferably comprises a rotating a knife roll 5 having at least one knife member 9 to provide an operative knife-member position and speed, and a fixed anvil 30 having at least one anvil member or knife 36. The knife roll and anvil roll have been positioned to provide an operative nip region 32 there between, and a substantially continuous target web 1 moved at a selected web speed through the nip region. A rotational positioning of the knife roll knife member has been coordinated with the positioning of its cooperating anvil member to provide an operative cutting engagement between the knife member and its cooperating anvil member, thereby cutting the moving web at cut locations which are intermittently spaced along a machine-direction 102 of the target web 1.

In particular aspects, the knife roll 5 can include a plurality of two or more, and alternatively three or more, knife-members 10 that are spaced apart along an outer circumference of the knife roll 5. The anvil 30 can include a plurality of two or more, and alternatively three or more, anvil-members 36 that are spaced apart along an outer perimeter of the anvil 30.

Preferably the two or more knife rolls 50, 60 are driven by separate drive means 15, 17, which are controlled by a central control system (not illustrated in FIG. 1) that coordinates the rotational positioning of the knife members of the two or knife rolls so as to coordinate the cutting of each perforating station relative to one another so that the moving web may be cut in a synchronized manner.

The cutting method and apparatus 20 can thereby form and produce a cut web 3, and the cut web 3 includes cuts or perforations 40 imposed by each perforating station. In a particular aspect, each cut can be distributed in a predetermined pattern or array. In another aspect, an individual line or other individual array of perforations which extends along the cross-direction 104 of the web can be produced at predetermined cut locations that are intermittently spaced apart at substantially non-contiguous areas or regions along the machine-direction 102 of the cut web 3.

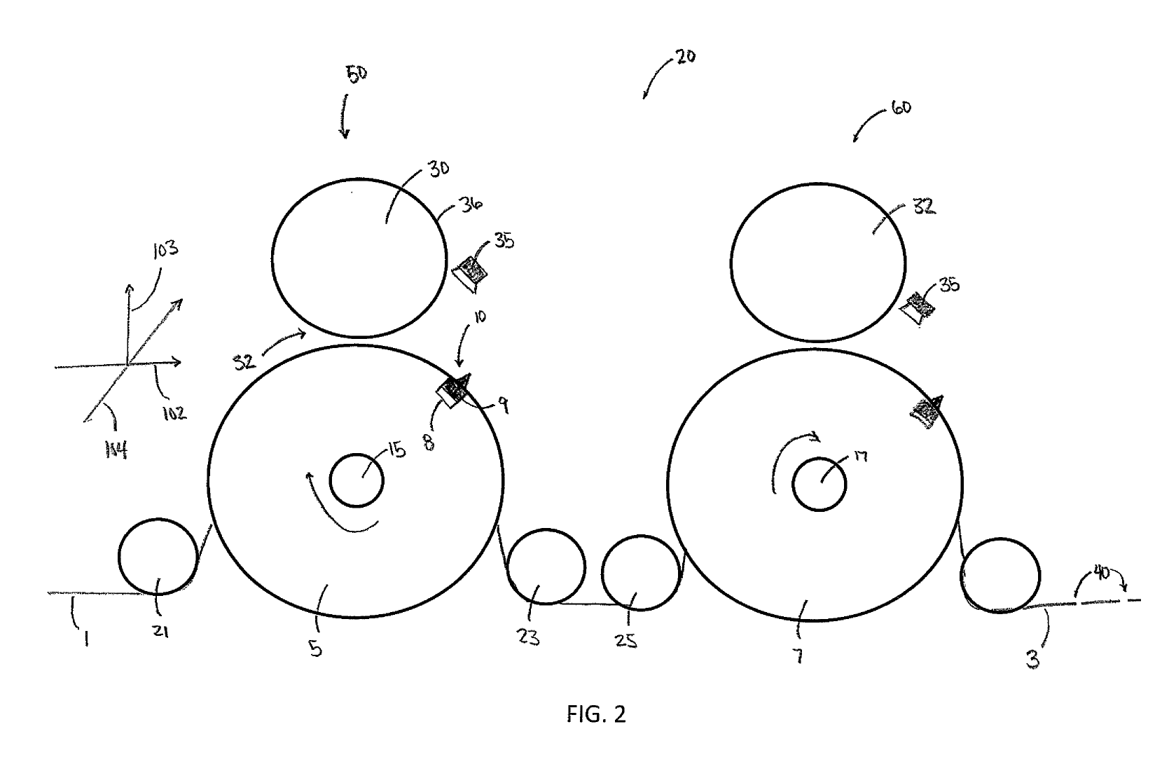

With reference to FIG. 2, an alternate embodiment for perforating a web using multiple perforating stations is illustrated. Shown is another embodiment for perforating a web using multiple perforating stations 50, 60, comprising an incoming web 1, an outgoing perforated web 2 having a first set of perforations, an outgoing web 3 having two sets of perforations, guide rollers 21, 23, 25 and 27, a first and a second rotating knife roll 5, 7 and a first and a second anvil rolls 30, 32. The first and second rotating knife roll 5, 7 are provided with suitable drive means (15, 17 drive means for driving the first and second rotating knife roll 5, 7) and rotate in the direction of their respective arrows as shown.

Each knife roll 5, 7 contains multiple pattern holding stations 9 (four shown) which contain a pattern of protruding perforation elements 10 which are arranged in the desired perforation pattern and protrude from the surface of the pattern roll. The number of elements can be adjusted to the length between perforating patterns and the diameter of the pattern roll. Advantageously, the pattern holding stations 9 can be replaceable so that the resulting perforation pattern can be changed or the protruding perforation elements can be replaced due to wear. Elements can also be placed at an angle to the axis of the roll to spread out the force of impact of the perforating pattern with the anvil. Alternatively, the elements can be placed on a helix pattern around the pattern rolls 5, 7 and the angle of the pattern rolls 5, 7 adjusted for the correct placement of the pattern in the cross machine direction of the web. The circumferential width of the pattern holding stations 9 depends upon the width of the perforation pattern. Where perforation elements are not present, the surface of the pattern holding station 9 is substantially flush with the surface of the pattern rolls 5, 7 with suitable clearance such that web does not contact the anvils 30, 32. Optionally, the pattern holding stations 9 can be supported by a resilient material 8, such as rubber, in order to further cushion the impact of the perforation elements against the anvil surface to further improve the wear characteristics of the apparatus. The pattern holding stations can alternatively be supported by liquid- or gas-filled bladders designed to absorb more shock and to further improve the wear characteristics of the apparatus.

In operation, in one embodiment, the anvil is positioned under tension and urged against the knife roll with sufficient pressure to create the perforations in the web. As shown, a cleaning brush or spray device 35 can be provided to maintain the surface of the anvil by removing dust and debris that may collect during the perforation step.

In other embodiments the anvil may be a rotatable anvil roll having at least one anvil disposed along its surface. The rotatable anvil roll is driven by a drive means, which may be coordinated with the rotational position and speed of a corresponding knife member to create a nip there between and cut a web passing through the nip.

To provide for increased perforation speeds and uniform perforated sheet lengths, the disclosure further provides a means for synchronizing the operation of a plurality of motors used to drive the individual perforating stations. To control the operation of such motors requires monitoring the position of the output shaft of each motor. Typically, a position transducer, such as a resolver connected to the output shaft of the motor, can provide an indication of the position of the shaft. The synchronization of a plurality of motors is preferably carried out by determining the position of each rotating motor shaft by an associated encoder and controlling the position and speed of the drive shaft with a drive controller. Appropriate corrective command messages may be developed for each motor by its associated universal drive controller and that the foregoing command messages may be transmitted to the proper motor.

In one embodiment synchronization of two or more discrete perforating station may be accomplished using phase control with a single drive for each knife roll. Preferably the knife rolls are similarly sized, have approximately the same skew angle and are disposed on a common frame. However in certain embodiments the rolls may be differently sized and may be skewed differently.

To control the operation of the knife roll drive motors requires monitoring the position of the output shaft of each motor. Typically, a position transducer, such as an encoder connected to the shaft of the motor, can provide an indication of the position of the shaft. To maintain synchronization of a plurality of motors requires that the position of each motor shaft be determined by its associated encoder; that as a result of the foregoing determination, appropriate corrective command signals be developed for each motor by its associated servo drive controller; and that the foregoing command signals be transmitted to the proper motor. Each of the foregoing steps preferably occurs simultaneously at each motor in order to effect motor synchronization. In one embodiment synchronization of the perforating apparatus may be accomplished using phase control with a dedicated servo drive controller for each knife roll. Suitable servo drive mechanisms and encoder mechanisms for the knife roll and anvil roll are commercially available and well known in the art.

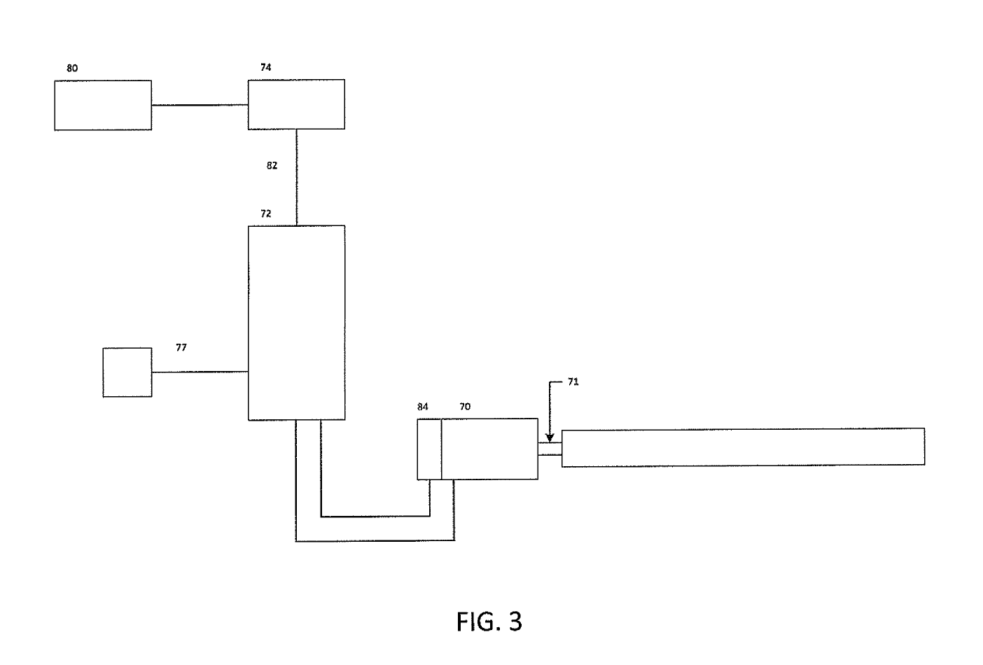

Referring to FIG. 3, there is one embodiment of a control and drive mechanism for controlling and driving a pair of spaced a part knife rolls. A rotational force of the motor 70 is transmitted to the rotating shaft of the knife roll (not illustrated) via an output shaft 71. Preferably the control mechanism permits the coordination and synchronization of the direction and velocity of movement of the first knife roll about the axis of a first rotating shaft with that of the second knife roll about the axis of the a second rotating shaft. In this manner the phases of the first and second knife rolls are synchronized with each other and their cutting may be coordinated in such a manner so as to reduce the overall vibrational energy transferred to the web, while still maintaining a high web speed and at least about 7000 impacts per minute. Further, loads applied to the motor and a power drive portion can be equalized, to reduce the vibration of the apparatus and improve the durability thereof.

Preferably the drive mechanism and their respective controls are identical for the first and second knife rolls. Accordingly, the drive mechanism and controls will be detailed with reference to a single knife roll. In one embodiment power is provided to the motor 70 by a servo drive controller, shown generally by the numeral 72, and control is performed by a programmable logic controller 74, which may be in communication with a computer 80. The servo drive controller 72 includes all of the necessary power conversion and regulation and is in communication with the programmable logic controller 74 through the communication link 82. The servo drive controller 72 performs the AC to DC conversion and contains the associated electronics and power structure to produce a pulse width modulated signal to the motor, input and output signal processing and the associated motor encoder feedback. The programmable logic controller 74 is common for any drive type, thus providing a common programming environment and control architecture for all types of drives. The remaining module, such as the drive technology module and its associated power module are the only system components that change from one power technology to another, such as from AC drives to DC drives and vice versa.

The servo drive controller 72 performs the necessary control of its associated motor 70 through the regulation of separate velocity, position and current loops internal to the drive. The encoder feedback is connected directly to the drive so that the motor rotational position is always known and processed for the desired control. The servo drive controller 72 also provides connections 77 for other drive input/output devices for other signal processing that needs to occur for the desired control.

The servo drive controller 72 is connected to the programmable logic controller 74 by a cable link 82. Based on the control algorithms programmed in the associated programmable logic controller 74 reference information is fed from the programmable logic controller 74 to the servo drive controller 72 through the cable link 82. The servo drive controller 72 receives the associated reference information and regulates each of the respective position, velocity and current loops to match the reference commands.

For each respective motor 70, an associated servo drive controller 72 is required. However, in certain embodiments a single programmable logic controller may be in communication with the separate servo drive controllers. Where each motor is controlled by a separate servo drive control and the servo drive controls are in communication with a single programmable logic controller, synchronization of the two drive axes would occur within the programmable logic controller so that proper regulation of the position and velocity of the two axes would occur. Each respective servo drive controller would communicate its associated position, velocity and current information to the programmable logic controller for monitoring the performance of the associated control algorithms. Diagnostic and other associated servo drive controller specific data can be obtained in the programmable logic controller through the use of the communication interface.

To synchronize the operation of each drive motor in the perforating stations requires the monitoring of the position of the output shaft of each motor. Typically, a position transducer, such as an encoder 84 connected to the output shaft 71 of the motor 70, can provide an indication of the position of the shaft 71. To maintain synchronization of a plurality of motors requires that the position of each motor shaft be determined by its associated encoder; that as a result of the foregoing determination, appropriate corrective command signals be developed for each motor by its associated servo drive controller; and that the foregoing command signals be transmitted to the proper motor. Each of the foregoing steps preferably occurs simultaneously at each motor in order to effect motor synchronization. In essence, the programmable logic controller 74 is synchronized with the associated servo drive controller 72 by transmitting synchronization data over the associated cable link. If there is a plurality of servo drive controllers 72, each would be synchronized through the reference signals received from the common programmable logic controller 72 and its associated control algorithms and control processes that keep all of the associated axes in a given programmable logic controller synchronized.

Where multiple servo drive controllers are employed, each servo drive controller receives its own respective reference signals from the programmable logic controller. Once the movement has been initiated for each motor, monitoring of the encoder feedback device at the servo drive controller occurs. The servo drive controllers monitor the motor position and velocity data from the encoder and regulate the position, velocity and current loops in order to achieve the commanded reference signals issued by the programmable logic controller.

By providing at least two perforating stations in synchronized control with one another the impact energy applied by each of the stations may remain substantially unchanged; however, both the web speed and the total impact rate may be increased dramatically. For example, in one particularly preferred embodiment the present invention provides at least two synchronized perforating stations which are capable of delivering a total of 7000 impacts per minute or more, such as from about 7000 to about 8000 impacts per minute, with low vibrational energy and without damaging the web. In this manner, high web velocities may be obtained such as greater than about 1000 m/min and more preferably greater than about 1250 m/min, such as from about 1250 to about 1500 m/min.

In further aspects, the two rotating perforating stations operate at different speeds to create lines of perforations or cuts that extend transversely across the web, and are spaced-apart at varying distances along the machine-direction of the web. In other aspects, the perforating stations can be configured to move out-of-phase with one another. The various aspects of roll synchronization can provide increased operational flexibility while maintaining substantially the same path of the target web.

What we claim is:

1. An apparatus for intermittently cutting a moving target web, comprising:
a. a first perforating station comprising a first rotating knife roll having at least one knife member to provide an operative knife-member position and speed and a first anvil member;
b. a second perforating station comprising a second rotating knife roll having at least one knife member to provide an operative knife-member position and speed and a second anvil member;
c. a drive means for driving the first and second knife rolls; and
d. a control means for coordinating the operative knife-member position and speed of the first and second knife members.

2. The apparatus of claim 1 wherein the first and second knife rolls are operatively connected to separate drive means, each drive means comprising a motor and a drive shaft.

3. The apparatus of claim 2 wherein the drive shaft further comprises an encoder.

4. The apparatus of claim 1 wherein each knife member and each anvil roll forms a nip region there-between, the nip region providing a selected amount of cutting interference.

5. The apparatus of claim 1 wherein the first and second anvils consist of an anvil block and at least one anvil member.

6. The apparatus of claim 1 wherein the first and second anvils consist of an rotatable anvil roll and at least one anvil member and the apparatus further comprises a drive means for driving the first and second anvils and a control means for controlling the anvil member speed and the web speed.

7. An apparatus for intermittently cutting a moving target web, comprising:
a. a first perforating station comprising a first knife roll which has at least one knife member and is rotatable to provide an operative knife-member position; a first anvil which has at least one anvil member, the anvil positioned to provide a first operative nip region between the anvil and the knife roll;
b. a second perforating station comprising a second knife roll which has at least one knife member and is rotatable to provide an operative knife-member position; a second anvil which has at least one anvil member, the anvil positioned to provide a second operative nip region between the anvil and the knife roll;
c. a transport system which moves a substantially continuous target web at a web speed through the nip region; and
d. a control system which synchronizes the rotational positioning of the first knife member with a rotational positioning of the second knife member.

8. The apparatus of claim 7 further comprising a knife encoder operatively connected to the first and second knife rolls to provide rotational, knife positioning data from the knife encoder to an operative electronic computer; a knife servo mechanism operatively controlled by the computer and rotationally drives the first and second knife rolls.

9. The apparatus of claim 7 wherein each of the first and second knife members and its cooperating anvil member are arranged to provide a selected amount of cutting interference in the nip region during the rotating of the knife roll and anvil roll.

10. The apparatus of claim 7 further comprising a pair of drive means comprising a motor and a shaft operatively connected to the first and second knife rolls.

11. The apparatus of claim 7 wherein the control system comprises a servo drive controller, a programmable logic controller and a computer in operative communication with one another.

12. The apparatus of claim 11 wherein each of the drive means is in operative communication with a servo drive controller.

13. The apparatus of claim 11 wherein the pair of servo drive controllers are in communication with a programmable logic controller.

14. An apparatus as recited in claim 7 wherein the first and second perforating stations have been configured to deliver at least about 7000 impacts per minute to the target web.

15. An apparatus as recited in claim 7 wherein the first and second perforating stations have been configured to deliver greater than about 7500 impacts per minute to the target web.

16. An apparatus as recited in claim 7 wherein the web speed has been configured to be at least about 1000 m/min.

17. An apparatus for intermittently cutting a moving target web, comprising:
a. a first perforating station comprising a first rotating knife roll having at least one knife member to provide an operative knife-member speed and a first anvil member, the first rotating knife roll driven by a first motor;
b. a second perforating station comprising a second rotating knife roll having at least one knife member to provide an operative knife-member speed and a second anvil member, the second rotating knife roll driven by a second motor;
c. a pair of servo drive controllers in operative communication with each of the first and second drive motors; and
d. a transport system which moves a substantially continuous target web.

18. The apparatus of claim 17 further comprising a drive shaft operative connecting the motor to the knife roll, the drive shaft having an encoder disposed thereon.

19. The apparatus of claim 17 further comprising a programmable logic controller in communication with the pair of servo drive controllers.

20. The apparatus of claim 17 further comprising a knife encoder operatively connected to the first and second knife rolls to provide rotational, knife positioning data from the knife encoder to the servo drive controller.
